(19) United States
(12) Patent Application Publication
(10) Pub. No.: US 2008/0096533 A1
(43) Pub. Date: Apr. 24, 2008

(54) Virtual Assistant With Real-Time Emotions

(75) Inventors: Giorgio Manfredi, Milano (MI) (IT); Claudio Gribaudo, Viverone (BI) (IT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kallideas SpA, Sesto S. Giovanni (MI) (IT)

(21) Appl. No.: 11/617,150

(22) Filed: Dec. 28, 2006

Related U.S. Application Data
(60) Provisional application No. 60/854,299, filed on Oct. 24, 2006.

(51) Int. Cl. H04L 12/58

(52) U.S. Cl. 455/412.1

(57) ABSTRACT

A modular digital assistant that detects user emotion and modifies its behavior accordingly. The desired emotion is produced in a first module and a transforming module then converts the emotion into the desired output medium. The degree or subtleness of the emotion can be varied. Where the emotion is not completely clear, the virtual assistant may prompt the user. The detected emotion can be used for the commercial purposes the virtual assistant is helping the user with. Various primary emotional input indicators are combined to determine a more complex emotion or secondary emotional state. The user's past interactions are combined with current emotion inputs to determine a users emotional state.

### CROSS-REFERENCES TO RELATED APPLICATIONS

This application claims priority from provisional application No. 60/854,299, entitled “Virtual Assistant with Real-Time Emotions”, filed on Oct. 24, 2006, which is incorporated herein in its entirety.

### BACKGROUND OF THE INVENTION

The present invention relates to virtual assistants for telephone, internet and other media. In particular, the invention relates to virtual assistants that respond to detected user emotion.

Automated responses to customer phone inquires are well known. They have evolved from pressing a number in response to questions to voice recognition systems. Similar automated response capabilities exist on Internet sites, often with a talking head whose lips move with the sound generated. By making such virtual assistants more life-like and easier to interact with, the number of people who will use them increases, decreasing the number wanting to talk to a live operator, and thus reducing costs.

Efforts have been made to make virtual assistants or voice response systems more lifelike and responsive to the user. U.S. Pat. No. 5,483,608 describes a voice response unit that automatically adapts to the speed with which the user responds. U.S. Pat. No. 5,553,121 varies voice menus and segments in accordance with the measured competence of the user.

Virtual assistants can be made more realistic by having varying moods, and having them respond to the emotions of a user. US Patent Application Publication No. 2003/0028498 “Customizable Expert Agent” shows an avatar with natural language for teaching and describes modifying a current mood of the avatar based on input (user responses to questions) indicating the user's mood (see par. 0475). U.S. Patent Application Publication No. 2002/0029203 “Electronic Personal Assistant with Personality Adaptation” describes a digital assistant that modifies its personality through interaction with user based on user behavior (determined from text and speech inputs).

Avaya U.S. Pat. No. 6,757,362 “Personal Virtual Assistant” describes a virtual assistant whose behavior can be changed by the user. The software can detect, from a voice input, the user's mood (e.g., anger), and vary the response accordingly (e.g., say “sorry”) [see cols. 43, 44].

### BRIEF SUMMARY OF THE INVENTION

The present invention provides a digital assistant that detects user emotion and modifies its behavior accordingly. In one embodiment, a modular system is provided, with the desired emotion for the virtual assistant being produced in a first module. A transforming module then converts the emotion into the desired output medium. For example, a happy emotion may be translated to a smiling face for a video output on a website, a cheerful tone of voice for a voice response unit over the telephone, or smiley face emoticon for a text message to a mobile phone. Conversely, input from these various media is normalized to present to the first module the user reaction.

In one embodiment, the degree or subtleness of the emotion can be varied. For example, there can be percentage variation in the degree of the emotion, such as the wideness of a smile, or addition of verbal comments. The percentage can be determined to match the detected percentage of the user's emotion. Alternately, or in addition, the percentage may be varied based on the context, such as having a virtual assistant for a bank more formal than one for a travel agent.

In another embodiment, the emotion of a user can be measured more accurately. Where the emotion is not completely clear, the virtual assistant may prompt the user in a way designed to generate more information on the user's emotion. This could be anything from a direct question (“Are you angry?”) to an off subject question designed to elicit a response indicating emotion (“Do you like my shirt?”). The percentage of emotion the virtual assistant shows could increase as the certainty about the user's emotion increases.

In one embodiment, the detected emotion can be used for purposes other than adjusting the emotion or response of the virtual assistant, such as the commercial purposes the virtual assistant is helping the user with. For example, if a user is determined to be angry, a discount on a product may be offered. In addition, the emotion detected may be used as an input to solving the problem of the user. For example, if the virtual assistant is helping with travel arrangements, the user emotion of anger my cause a response asking if the user would like to see another travel option.

In one embodiment, various primary emotional input indicators are combined to determine a more complex emotion or secondary emotional state. For example, primary emotions may include fear, disgust, anger, joy, etc. Secondary emotions may include outrage, cruelty, betrayal, disappointment, etc. If there is ambiguity because of different emotional inputs, additional prompting, as described above, can be used to resolve the ambiguity.

In one embodiment, the user's past interactions are combined with current emotion inputs to determine a user's emotional state.

### BRIEF DESCRIPTION OF THE DRAWINGS

FIG. 1 is a block diagram of a virtual assistant architecture according to one embodiment of the invention.

FIG. 2 is a block diagram of an embodiment of the invention showing the network connections.

FIG. 3 is a diagram of an embodiment of an array which is passed to Janus as a result of neural network computation.

FIG. 4 is a flow chart illustrating the dialogue process according to an embodiment of the invention.

FIG. 5 is a diagram illustrating the conversion of emotions from different media into a common protocol according to an embodiment of the invention.

### DETAILED DESCRIPTION OF THE INVENTION

### Overall System

Embodiments of the present invention provide a Software Anthropomorphous (human-like) Agent able to hold a dialogue with human end-users in order to both identify their need and provide the best response to it. This is accomplished by means of the agent's capability to manage a natural dialogue. The dialogue both (1) collects and passes on informative content as well as (2) provides emotional elements typical of a common conversation between humans. This is done using a homogeneous mode (way) communication technology.

The virtual agent is able to dynamically construct in real-time a dialogue and related emotional manifestations supported by both precise inputs and a tight objective relevance, including the context of those inputs. The virtual agent's capability for holding a dialogue originates from Artificial Intelligence integration that directs (supervises) actions and allows self-learning.

The invention operates to abstract relational dynamics/man-machine interactions from communication technology adopted by human users, and to create a unique homogeneous junction (knot) of dialogue management which is targeted to lead an information exchange to identify a specific need and the best response (answer) available on the interrogated database.

The Virtual Agent is modular, and composed of many blocks, or functional modules (or applications). Each module performs a sequence of stated functions. The modules have been grouped together into layers which specify the functional typology a module belongs to.

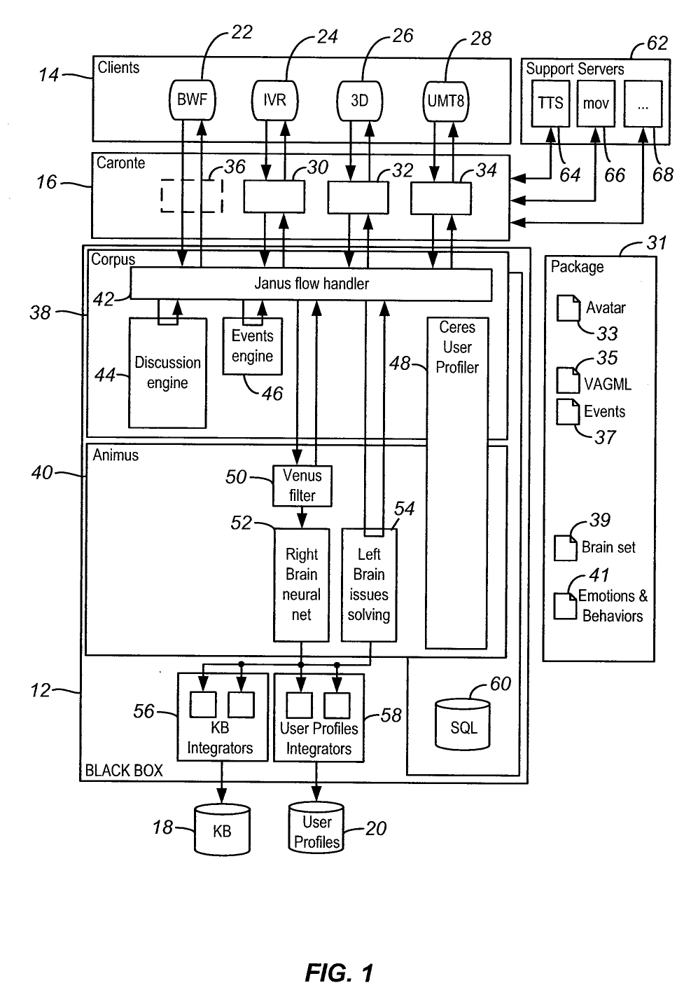

FIG. 1 is a block diagram of a virtual assistant architecture according to one embodiment of the invention. A “black box” 12 is an embodiment of the virtual assistant core. Module 12 receives inputs from a client layer 14. A transform layer 16 transforms the client inputs into a normalized format, and conversely transforms normalized outputs into media specific outputs. Module 12 interacts on the other end with client databases such as a Knowledge Base (KB) 18 and user profiles 20.

Client layer 14 includes various media specific user interfaces, such as a flash unit 22 (SWF, Small Web Format or ShockWave Flash), an Interactive Voice Response unit 24 (IVR), a video stream 26 (3D), such as from a webcam, and a broadband mobile phone (UMTS) 28. Other inputs may be used as well.

The client layer inputs are provided through a transform layer 16 which includes transform modules 30, 32 and 34. An optional module 36 is used, alternately this input, or another selected input, can be input directly. In this example, the direct input can be already in the normalized format. Transform layer 16 uses standard support server modules 62, such as a Text-to-Speech application 64, a mov application 66, and other modules 68. These may be applications that a client has available at its server.

Module 12 includes a “Corpus” layer 38 and an “Animus” layer 40. Layer 38 includes a flow handler 42. The flow handler provides appropriate data to a discussion engine 44 and an events engine 46. It also provides data to layer 40. A user profiler 48 exists in both layers.

Layer 40 includes a filter 50, a Right Brain neural network 52 and a Left Brain issues solving module 54. Module 12 further includes knowledge base integrators 56 and user profiles integrators 58 which operate using an SQL application 60.

In one embodiment, layer 14 and support servers 62 are on client servers. Transformation layer 16 and layer 12 are on the virtual assistant server, which communicates with the client server over the Internet. The knowledge base 18 and user profiles 20 are also on client servers. The integrators 56 and 58 may alternately be on the virtual assistant server(s) or the client server(s).

The first layer contains client applications, those applications directly interacting with users. Examples of applications belonging to this layer are web applications collecting input text from a user and showing a video virtual assistant; “kiosk” applications that can perform voice recognition operations and show a user a document as a response to its inquiry; IVR systems which provide audio answers to customer requests; etc.

The second layer contains Caronte applications. These modules primarily arrange a connection between client applications of the first layer above and a Virtual Assistant black box (see below). In addition, they also manage video, audio, and other content and, in general, all files that have to be transmitted to a user.

The third and fourth layer together make up the Virtual Assistant's black box, which is the bin of all those modules that build up the intimate part of the agent.

As per its name, the black box is a closed box that interacts with third party applications, by getting an enquiry and producing an output response, with no need for the third party to understand the Virtual Assistant internal operation. This interaction is performed by a proprietary protocol named VAMP (Virtual Assistant Module Protocol). VAMP is used for communications coming into, and going out of, the black box. The output is a file EXML (Emotional XML) which includes a response to an inquiry and transmits all information needed for a video and audio rendering of a emotional avatar.

The Black box 12 only allows in incoming a group of information that is formatted by using VAMP, and only produces an outgoing EXML file containing a bulk of info sent through VAMP protocol. Video and audio rendering parts, transmission to screen of selected information, activities such as file dispatching and similar actions are therefore fully managed by applications belonging to layers Caronte and Client by using specific data contained in an EXML file.

Inside the black box 12 there is a third layer named corpus 38. The corpus layer contains a group of modules dedicated to performing standardization and cataloguing on raw received inquiries. Corpus is also in charge the dialog flow management in order to identify the user's need.

A fourth layer, inside black box 12, named animus (40) is an artificial intelligence engine, internally containing the emotional and behavioral engines and the issue solving engine. This layer also interacts with external informative systems necessary to complete the Virtual Assistant's application context (relevant knowledge base and end user profiling data).

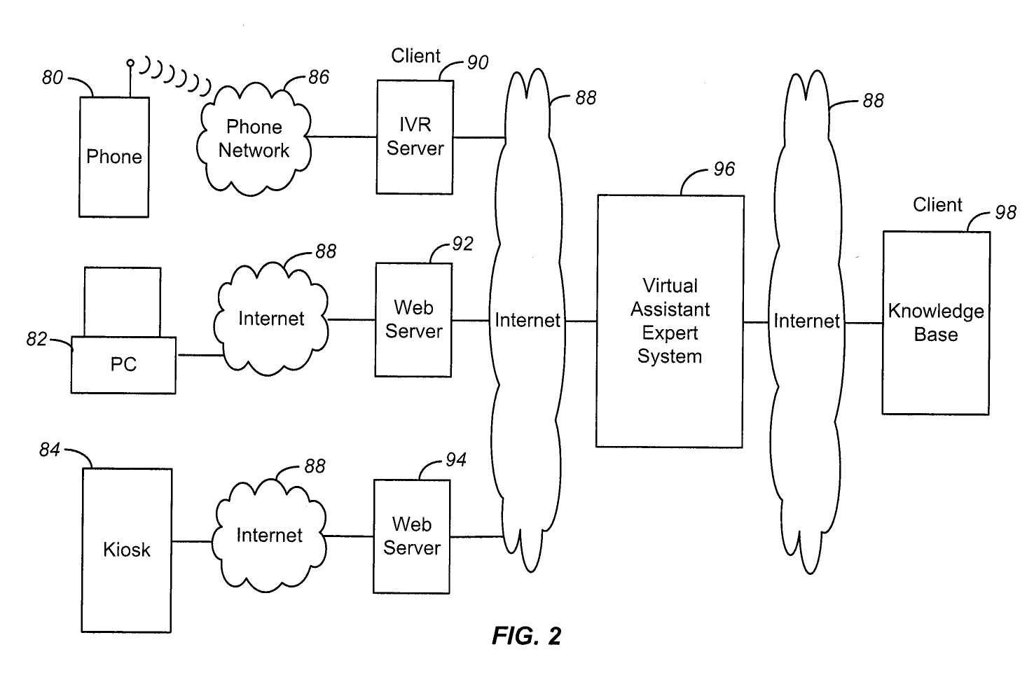

FIG. 2 is a block diagram of an embodiment of the invention showing the network connections. Examples of 3 input devices are shown, a mobile phone 80, a personal computer 82 and a kiosk 84. Phone 80 communicates over a phone network 86 with a client IVR server 90. Computer 82 and kiosk 84 communicate over the Internet 88 with client web servers 92 and 94. Servers 90, 92 and 94 communicate over the Internet 88 with a Virtual Assistant and Expert System 96. The Expert System communicates over Internet 88 with a client knowledge base 98, which may be on a separate server.

### Layer Modules Description

1. Client Layer

This layer 14 contains all the packages (applications) devoted to interact with Caronte (on the lower side in FIG. 1) and with the user (on the upper side). Each different kind of client needs a specific package 31. For example, there may be packages for:

Web client

3D flash engine

Kiosk

IVR

UMTS handset

IPTV

Others

These packages are specific applications for every different client. A specific application is created, by using a language and a protocol compatible with the client, and able to communicate with Caronte about:

(1) information to be transmitted to Caronte originated by reference media (input)

(2) information to be transmitted to user through reference media (output)

(3) transmission synchronization (handshaking)

For every application devoted to a user, the elements to be shaped in package 31 are:

Avatar 33—the relationship between the assistant's actions and dialogue status;

VAGML 35—the grammar subtext to the dialogue to be managed;

List of events 37—a list to be managed and solution action;

Brain Set 39—mathematical models mandatory for managing a problem through A.I.; and

Emotional & Behaviours module 41—the map of the Virtual Assistant's emotional and behavioural status with reference to problem management.

These packages are developed using the client's programming languages and protocols (e.g. http protocols). Client applications call to the Caronte Layer to submit their requests and obtain answers.

2. Caronte (Connecting Layer)

These layer modules are devoted to translate and connect the client packages to the Virtual Assistant Black box. The communications between Caronte and the client packages are based on shared http protocols. These protocols may be different according to the communication media. In contrast, the communication between Caronte layer 16 and the Black Box 12 is based on a proprietary protocol named VAMP (Virtual Assistant Module Protocol). Alternately, other protocols may be used. Answers coming from the Black Box directed to Caronte will contain a EXML (Emotional XML) file encapsulated in VAMP.

Caronte is not only devoted to manage communications between client and the black box, but it is responsible for managing media resources, audio, video, files, and all that is needed to guarantee the correct client behavior.

For example it will be Caronte which manages information (enclosed in an EXML file) regarding avatar animation, by activating a 3D video rendering engine and driving its output presentation.

3. Third Stratus: Corpus [Black Box]

3.1. Janus—flow handler and message dispatcher 42

The Janus functionalities are as follows:
1. Janus listens for calls incoming from outside the black box, made by one/many Caronte layers, and to deliver answers to them.
2. Janus launches the Discussion Engine, language analysis process, able to format inquiries so that they can be transmitted to AI engines. For each user session a different instance of Discussion Engine is launched.
3. Janus launches the Event Engine and its events management process. For each user session a different instance of Event Engine is launched.
4. Janus performs the dispatch of formatted data to the AI engines and receives from the AI engines answers that already include a EXML file, as mentioned above

Janus module 42 is effectively a message dispatcher which communicates with Discussion Engine 44, Event Engine 46 and AI Engines 52, 54 through the VAMP protocol.

The message flow, set by Janus in accordance with default values at the reception of every single incoming request, is inserted into the VAMP protocol itself. In fact, Janus makes use, in several steps, of flow information included in communication packages sent between the modules. The message flow is not actually a predetermined flow. All black box modules have the capability to modify that flow, depending on request typology and its subsequent processing. This is done in order to optimize resource usage and assure flexibility in Virtual Assistant adaptability to different usability typologies.

As an example, following an event notified by a user who has increased his tone of voice, the Event Engine could decide, rather than transmitting his request directly through the artificial intelligence engines, to immediately notify Caronte to display to the user an avatar that is amazed at his reaction. In this case, the Event Engine would act by autonomously modifying the flow.

3.2. Discussion Engine

Discussion Engine 44 is an engine whose aim is to interpret natural speaking and which is based on an adopted lexicon and an ontological engine.

Its functionality is, inside a received free text, to detect elements needed to formulate a request to be sent to the AI engines. It makes use of grammatical and lexical files specific for a Virtual Assistant which have to be consistent with decision rules set by the AI engines.

Many other Discussion Engine grammatical and lexical files shall be common to various Virtual Assistant declensions (inflections of words), as per several forms of compliments or requests for additional information.

The format of those grammatical files is based upon AIML (Artificial Intelligence Markup Language), modified and enhanced as a format called VAGML (Virtual Assistant Grammar Markup Language). The grammatical files make use of Regular Expressions, a technology adapted for analyzing, handling and manipulating text. The grammatics themselves allow rules to be fixed, which can be manipulated by specific Artificial Intelligence engines.

3.3. Event Engine

In order to allow the Virtual Assistant to perform “real-time” reactions to unexpected events, Janus routes requests first to Event Engine 46, before transmitting them to the AI Engines. Event Engine 46 analyzes requests and determines whether there are events requiring immediate reactions. If so, Event Engine 46 can therefore build EXML files which are sent back to Caronte before the AI Engines formulate an answer.

There are two main typologies of events managed by Event Engine.
1. Events signalled in incoming messages from Caronte applications. E.g., in the case of voice recognition, the signalled event could be “customer started talking”. This information, upon reaching the Event Engine, could activate an immediate generation of a EXML file with information relevant to a rendering for an avatar acting in a listening position. The file would be immediately transmitted to the Caronte application for video implementation, to be afterwards transmitted to the client application.
2. Events detected by the Event Engine itself. E.g., a very light lexical parser could immediately identify the possible presence of insulting words and, through the same process described above, the Event Engine can create a file of reaction for the Virtual Assistant avatar of surprised position, before a textual answer is built and dispatched.
   4. Fourth Stratus—Animus 40 [Black Box]

4.1. Left Brain Engine 54: Issue Solving

This AI engine 54, based on a Bayesian network engine, is devoted to solving problems. In other words, it identifies the right solution for a problem, choosing among multiple solutions. There are often many possible causes of the problem, and there is a need to manage many variables, some of which are unknown.

This is a standard expert system except that it has the peculiarity that it accepts and manages as inputs the user emotions, and it is able to add an emotional part to the standard expert system output (questions & answers). The answers to the user can be provided with appropriate emotion. Additionally, the emotion detected can vary the response provided. For example, if a good long-term customer is found to be angry, the system may generate an offer for a discount to address the anger. If the user is detected to be frustrated when being given choices for a hotel, additional choices may be generated, or the user may be prompted to try to determine the source of the frustration.

The main elements that characterize this module are:

Question & Response

Evidence Based Decision

Decision Support Rules

Beliefs Networks

Decision Trees

4.2. Right Brain Engine: Emotional Model

Right Brain engine 52 is an artificial intelligence engine able to reproduce behavioural models pertinent to common dialogue interactions, typical of a human being, as per various types of compliments or general discussions. It is actually able to generate textual answers to requests whose aim is not that of solving a specific problem (activity ascribed to Left Brain, see below).

Besides the conversational part, in addition the Virtual Assistant's emotive part resides in Right Brain engine 52. An emotional and behavioural model during interaction is able to determine the emotional state of the Virtual Assistant. This model assigns values to specific variables in accordance with the emotive and behavioural model adopted, variables which determine the Virtual Assistant's emotive reactions and mood.

Like all other modules, the Right Brain engine 52 is able to modify the flow of answer generation and moreover, in case a request is identified as fully manageable by the Right Brain (request not targeted to solve a problem or to get a specific information), is actually able to avoid routing the request to the Left Brain, with the aim of resource optimization.

In order to perform this, the Right Brain receives from Janus information needed to process the emotive state, and then provides the resulting calculation to Janus to indicate how to modify other module results before transferring them to Caronte, which will display them to the user. This way the Right Brain engine is able to directly act, for example, on words to be used, on tone of voice or on expressions to be used to communicate emotions (this last case if the user is interacting through a 3D model). These emotions are the output of a neural network processing which receives at its input several parameters about the user. In the case of a vocal interaction, information on present vocal tone is collected, as well as its fluctuation in the time interval analyzed. Other inputs include the formality of the language being used and identified key words of the dialogue used so far. In one embodiment, the neural network implemented is a recurrent type, that is able to memorize its previous status and use it as an input to evolve to the following status.

By means of a suitable selection of network training examples, we are able to coach it to answer in a way that corresponds to a desired “emotive profile.” The Virtual Assistant thus has a kind of “character” to be selected in advance of use.

A further source of information used as inputs by the neural network engine are user profiles. The Ceres user profiler 48 stores several users' characteristics, among which are the tone used for previous dialogues. Thus, the Assistant is able to decide a customized approach to every single known user.

The Neural network outputs are emotional codes, which are interpreted by the other modules. In one example, in case the network chooses to show happiness, it will transmit to flow manager 42 a happy tag followed by indications in percentage scale of its intensity at that precise moment. That tag received by Janus will then be inserted in a proper way into different output typologies available or a selection of them. For example: into text (which will be read with a different tonality) or will be interpreted to influence a 3D model to generate, for example, a smile.

Right Brain at Work

For each typology of emotional analysis methodology, Table 1 below indicates the main elements to be monitored and their relative value as indicators of the user's emotion.

TABLE 1

| | | Veridicity |
|---|---|---|
| EMOTIONAL | | (Value as indicator |
| ANALYSIS | Main Factors | of emotion) |
| Facial | a) Deformation of mouth shapes from its neutral position | medium |
| Expressions | b) Deformation of eyes shapes from their neutral position | |
| | c) Deformation of cheekbones shapes from their neutral position | |
| | d Deformation of forehead and eyebrows shapes from their | |
| | neutral position | |
| Voice | a) Alteration of voice tone from initial value or from reference one | high |
| | b) Alteration of spoken speed from initial value or from | |
| | reference one | |
| | c) Alteration of space-time between phonemes from initial | |
| | value or from reference one | |
| Writing | a) Use of conventional forms or key-words | low |
| | b) Use of specific writing registers | |
| | c) Temporal lag between starting moment of answer typing | |
| | from initial value or from reference one | |
| | d) Volume and frequency of corrections and mistyping | |
| Speaking | a) Use of conventional forms or key-words | low |
| | b) Temporal lag between starting moment of answer from initial | |
| | value or from reference one | |
| Gesture | a) Hands position and movement | medium |
| | b) Arms position and movement | |
| | c) Bust position and movement | |
| | d) Head position and movement | |
| | e) Legs and feet position and movement | |
| Biometric | a) Ocular movement | high |
| Parameters | b) Perspiration | |
| | c) Temperature | |
| | d) Breathing | |
| | e) Cardiac heartbeat | |
| Emotional | a) Use of conventional symbols | low |
| Symbols | b) Use of suggested symbols | |
| Environmental | a) Presence of an environmental event catalogued as supplier of | unsettled |
| | a emotional stimulus | |

Chosen weights of key factors for a user's emotional analysis cannot be directly and in any explicit way inserted into neural network, as it has to be trained. Training a neural network requires a training set, or a set (range) of input values together with their correct related output values, to be submitted to network so that it is autonomously enabled to learn how to behave as per the training examples. The proper choice of those examples forming the training set will provide a coherent rendering of the virtual assistant's emotions in combination with ‘emotional profiles’ previously chosen for the desired personality of the virtual assistant.

In one embodiment, the difficulty of telling a neural network the weight to assign to each single input is recognized. Instead, the neural network is trained on the priority of some key inputs by performing a very accurate selection of training cases. Those training cases will contain examples that are meaningful with respect to the relevance of one input compared to another input. If the training cases selection is coherent with a chosen emotive profile, the neural network will be able to simulate such an emotive behaviour and, always keeping in mind what is a neural network by definition, it will approximate precise values provided during training, diverging in average no more than a previously fixed value. In one embodiment, the value of the interval of the average error between network output and correct data is more significant than in other neural network applications; actually it can be observed as a light deviation (anyway controlled by a superior threshold) spontaneously occurred from the chosen emotive profile; it could be interpreted as a customization of character implemented by neural network itself and not predictable as per its form.

In order to better understand how input processing can be performed by the Right Brain engine, a description of an example case follows. Assume only two sources of data acquisition are available among all those described above, namely video (which means information about user's facial expressions and its body position) and textual (that is user inserting text through his pc keyboard). Assume that the user approaches the Virtual Assistant by writing: “Hi, dummy?” and that images show that he has an eyebrow position typical of a thoughtful face, with lips slightly shut. The Right Brain engine will interpret the user's emotive state as not serene, and will assign a discrete value to the level of anger perceived. The output displayed by the Virtual Assistant to the user could be an emotion synthesizing a percentage of anger, astonishment and disgust. Going over this example, real behaviour in a similar case can have a different output in accordance with what emotional profile the neural network was trained for.

Alternately, consider the example above but, as a difference in the described video data, the user has a deformed mouth shape recalling a sort of smile sign, a raised eyebrow and also eyes in a shape typical of a smiling face. The virtual assistant will determine that the user feels like he is on familiar terms with the virtual assistant, and can therefore genuinely allow himself a joking approach. In a similar situation, the virtual assistant will choose how to behave on the basis of the training provided to the Right Brain engine. For example, the virtual assistant could laugh, communicating happiness, or, if it's the very first time that the user behaves like this, could alternatively display surprise and a small (but effective) percentage of happiness.

It was previously shown how the Right Brain engine interacts with the whole system, but we didn't describe the concrete output which is transmitted to Janus. Keeping in mind what has been said so far, it's possible to understand that information about the virtual assistant emotive state, as a matter of fact, is described by the whole set of “basic” emotions singled out. The right brain engine will output single neurons (e.g., six, one for each of six emotions, although more or less could be used), which will transmit the emotion level (percentage) they are representing to the Venus filter, which organizes them in an array and sends them as a final processing result to Janus, which will re-organize the flow in a proper way on the basis of the values received.

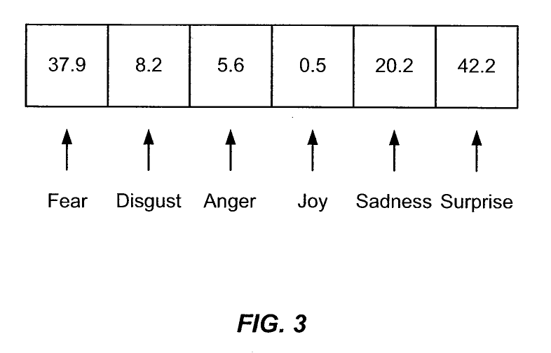

FIG. 3 is a diagram of an embodiment of an array which is passed to Janus as a result of neural network computation. Each position of the array represents a basic emotion. For each basic emotion a percentage (e.g., 37.9% fear, 8.2% disgust, etc.) is provided to the other modules. In this case, the values represent a situation of surprise and fear. For example, as if the virtual assistant is facing a sudden and somehow frightful event. By receiving these data, Janus is able to indicate to different modules how to behave, so that spoken is pronounced consistently to emotion and a similar command is transmitted to the 3D model.

4.3. Venus: Behavior Module

In one embodiment, in order to simplify programming only one emotional and behavioural model is used, the model incorporated into Right Brain engine 52 as described above. In order to obtain emotions and behaviours customized for every user, Venus filter 50 is added. Venus filter 50 has two functions:

(1) It is responsible for Right Brain integration into black box 12;

(2) It modifies the right brain output.

Venus filter 50 directly interacts with Right Brain engine 52, receiving variables calculated by the emotional and behavioural model of the right brain. The Right Brain calculates emotive and behavioural variables on the basis of the neural model adopted, and then transmits those variables values to Venus filter 50. The Venus filter modifies and outputs values on the basis of customized parameters for of every virtual assistant. So Venus, by amplifying, reducing or otherwise modifying the emotive and behavioural answer, practically customizes the virtual assistant behavior. The Venus filter is thus actually the emotive and behavioural profiler for the virtual assistant.

4.4. Ceres: User Behaviour Profiler

Ceres behavioural profiler 48 is a service that allows third and fourth layer modules to perform a user profiling. The data dealt with is profiling data internal to black box 12, not external data included in databases existing and accessible by means of common user profiling products (i.e., CRM products). Ceres is actually able to provide relevant profiling data to several other modules. Ceres can also way make use of an SQL service to store data which is then called as needed, to supply to other modules requiring profiling data. A typical example is that of a user's personal tastes, which are not stored in a company's database. For example, does the user like to have a friendly and confidential approach in dialogue wording.

A number of modules use the user profile information from Ceres User Behaviour profiler 48. In one embodiment, the user profiler information is used by Corpus module 38, in particular by Discussion Engine 44. A user's linguistic peculiarities are recorded in discussion engine 44. Animus module 40 also uses the user profile information. In particular, both right brain engine 52 and left brain engine 54 use the user profile information.

### Dialogue Process Description

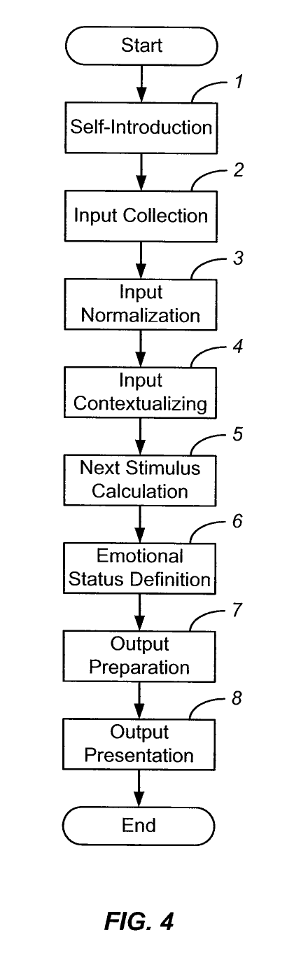

To describe the process it's useful to cut down a dialogue between the Virtual Assistant and a human end-user into serial steps which the system repeats until it identifies a need and, accordingly, provides an answer to it. This is illustrated in the flow chart of FIG. 4.

Step 1: Self-Introduction

In this step two main events may occur:
Virtual Assistant introduces itself and discloses its purpose
Virtual Assistant identifies its human interface, if so required and allowed by related service

This step, although not mandatory, allows a first raw formulation of a line of conversation management (“we are here (only/mainly) to talk about this range of information”). It also provides a starting point enriched with the user's profile knowledge. Generally speaking, this provides the user with the context.

VA self-introduction can even be skipped, since it can be implicit in the usage context (a VA in an airport kiosk by the check-in area discloses immediately its purpose).

The VA self-introduction step might be missing, so we have to take into consideration a dialogue which first has this basic ambiguity.

Step 2: Input Collection

In this step are assembled user (and surrounding environmental) reactions to dispatched stimulus. We call these kinds of reactions “user inputs” which we are able to classify into three typologies:
a. Synchronous Data User Inputs: phrases or actions from a user whose meaning can be precisely identified and is directly pertinent to proposed stimulus; i.e. an answer to a presented question or a key pressed upon request or a question or remark originated by an event;
b. Asynchronous Data User Inputs: phrases or actions from user whose meaning can't be combined with provided stimulus; i.e. a question following a question made by VA or a key pressed without any request or an answer or remark clearly not pertinent to provided stimulus;
c. Emotional User Inputs: inputs determining the emotional status of user on that frame of interaction;

There is a different category of inputs detected which is not originated from the user. This is Environmental Inputs, which are inputs originated by the environment on the frame of interaction. This kind of input may come from different media (phone, TV, computer, other devices . . . ).

Step 3: Input Normalization

The different input typologies described above are normalized. That is, they are translated into a specific proprietary protocol whose aim is to allow the system to operate on dialogue dynamics with a user apart from the adopted communication media.

Step 4: Input Contextualizing

Collected inputs are then contextualized, or placed in a dialogue flow and linked to available information about context (user's profile, probable conversation purpose, additional data useful to define conversation environment, . . . )

The dialogue flow and its context have been previously fixed and are represented by a model based on artificial intelligence able to manage a dialogue in two ways (not mutually exclusive)

1. identify a user's need

2. solve a problem

Step 5: Next Stimulus Calculation

By means of said model, the system is now able to understand if it has identified the need and if it has a solution to the need. The system is therefore in a status requiring the dispatch of additional stimulus or suggesting a final answer.

The answer to be provided can be embedded in the dialogue model or can be obtained by searching and collecting by a database (or knowledge base). The answer can be generated by forming a query to a knowledge base.

Step 6: Emotional Status Definition

Before sending a further stimulus (question, sentence, action) or the answer, there is an “emotional part loading.” That is, the Virtual Assistant is provided with an emotional status appropriate for dialogue flow, stimulus to be sent or the answer.

This is performed in two ways:
by extracting emotional valence by proposed stimulus (valence is a static value previously allocated to stimulus)
by dynamically deducing a emotional status by dialogue flow status and by context

The Virtual Assistant makes use of an additional model of artificial intelligence representing an emotive map and thus dedicated to identify the emotional status suitable for that situation.

Step 7: Output Preparation

At this step an output is prepared, that is the VA is directed to provide the stimulus and the related emotional status. Everything is still calculated in a transparent mode with respect to the media of delivery, an output string is composed in conformity with the internal protocol

Step 8: Output Presentation

An output string is then translated into a sequence of operations, typical of the media used to represent it. In example:
considering a PC, a text for the answer and related emotional vocal synthesis are prepared and then action requested by stimulus is performed (document presentation, e-mail posting, . . . ); at the same time, VA 2D/3D rendering is calculated in order to lead it to show a relevant emotional status
in a phone call, everything is similar except for the rendering;
in a SMS the text for the answer is prepared with the addition of an emoticon relevant to the emotional status

It's important to remark that even a pure text message needs to be prepared with respect to the addition of those literal parts representative of relevant emotional status.

With reference to the flow described above, the VA of this invention has a man/machine dialogue that is uniform and independent of the adopted media. The particular media is taken into consideration only on input collection (step 2) and output presentation (step 8).

### Inputted Emotions Collection and their Representation Through Different Media

The Caronte layer analyzes inputs coming from each individual media, and separately for each individual media, through an internal codification of emotional status, in order to capture user's emotive state. Elements analyzed for this purpose include:

facial expressions

voice

writing

speaking

gesture

emotional symbols

environmental

user behavioral profile

The elements available depending on the potential of the media used and on the service provided.

On the hypothesis of no service limitations, the following table shows the emotional analysis theoretically possible on each media:

EMOTIONAL ANALYSIS

| | | | Kiosk with | | |
|---|---|---|---|---|---|
| | | | touch screen | | |
| | Computer with | | and web cam | | |
| | web cam (no | | (no keyboard | | |
| EMOTIONAL | voice | | and no voice | | Video |
| ANALYSIS | interaction) | IVR | interaction) | SMS | Handset |
| facial | Yes | No | Yes | No | Yes |
| expressions | | | | | |
| Voice | No | Yes | No | No | Yes |
| Writing | Yes | No | No | Yes | No |
| Speaking | No | Yes | No | No | Yes |
| Gesture | Yes | No | Yes | No | No |
| emotional | Yes | No | Yes | Yes | Yes |
| symbols | | | | | |
| environmental | Yes | No | Yes | No | No |

The description above is not exhaustive, moreover a technological evolution in media analysis may enhance the capabilities: i.e. an upgrade on a PC with a voice over IP system enables analysis of voice and speaking.

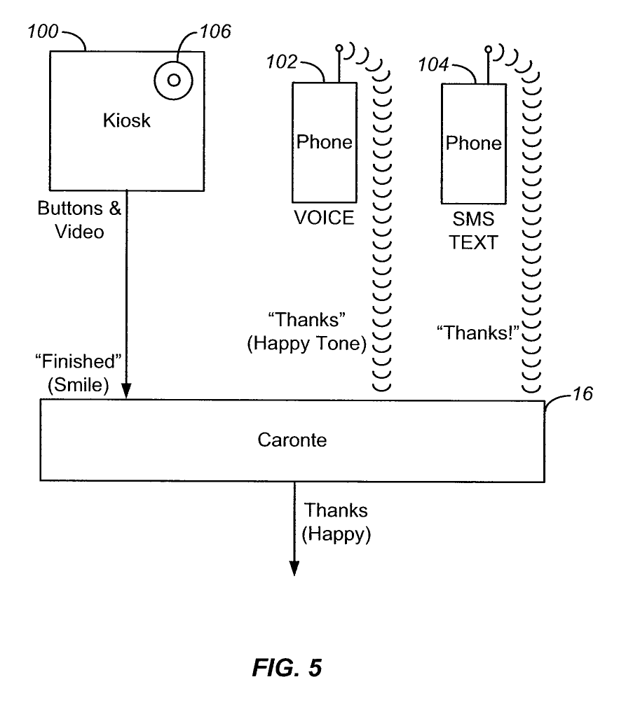

FIG. 5 is a diagram illustrating the conversion of emotions from different media into a common protocol according to an embodiment of the invention. Shown are 3 different media type inputs, a kiosk 100 (with buttons and video), a mobile phone 102 (using voice) and a mobile phone 104 (use SMS text messaging). In the example shown, the kiosk includes a camera 106 which provides a image of a user's face, with software for expression recognition (note this software could alternately be on a remote client server or in the caronte layer 16 of the expert system). The software would detect a user smile, which accompanies the button press for “finished.”

Phone 102 provides a voice signal saying “thanks.” Software in a client web server (not shown) would interpret the intonation and conclude there is a happy tone of the voice as it says “thanks.” This software could also be in the Caronte layer or elsewhere. Finally, phone 104 sends a text message “thanks” with the only indication of emotion being the exclamation point.

Caronte layer 16 receives all 3 inputs, and concludes all are showing the emotion “happy.” Thus, the message “thanks” is forwarded to the expert system along with a tag indicating that the emotion is “happy.” In this example, there can also be a common protocol used for the response itself, if desired, with the “finished” button being converted into a “thanks” due to the fact that it is accompanied by a smile. In other words, the detected emotion may also be interpreted as a verbal or test response in one embodiment.

We next clarify how, during similar analysis, a mapping is performed between catalogued emotions and collected input.

Facial Expressions Analysis

In a movie by means of a video cam, a face is seen as a bulk of pixels of different colors. By applying ordinary parsing techniques to the image it is possible to identify, to control and to measure movements of those relevant elements composing a face: eyes, mouth, cheekbones and forehead. If we represent these structural elements as a bulk of polygons (a typical technique of digital graphic animation) we may create a univocal relation between the vertex of facial polygons position and the emotion they are representing. By checking those polygons, moreover by measuring the distance between a specific position and the same position “at rest,” we can also measure the intensity of an emotion. Finally we can detect emotional situations which are classified as per their mixed facial expressions: i.e.

hysteria—>hysteric cry=evidence of a simultaneous situation of cry+laugh with strong alteration of the resting status of labial part;

happiness—>cry of joy=evidence of a simultaneous situation of cry+laugh with medium alteration of the resting status of labial part;

One embodiment uses the emotions representation, by means of facial expression, catalogued by Making Comics (www.kk.org/cooltools/archives/001441.php).

Voice Analysis

There are well-established techniques to obtain a user's emotive state from the vocal spectrum. These techniques mainly differ in accuracy and interpretation. If the VA works well using the spectrum analysis developed by third parties, we only have to create the right mapping of what is interpreted by the third parties system to the catalogue emotive (see § “User's emotion calculation”).

Writing Linguistic Analysis

By analyzing text that come from a user, it is then possible to extract an emotive content. In a written text we recognize two typologies of elements characterizing an emotional status:
1. Those words, expressions or phrases properly written to signify an emotive status (i.e.: “great!!” or “it's wonderful” or “I'm so happy for . . . ”) and which typically are asynchronous with regard to dialogue flow; they are thus processed as a particular type of symbols (see § “Symbols Analysis”), and not as per phrases on which to perform a linguistic analysis;
2. Words and phrases which are adopted to make explicit information and concepts. In this case a linguistic analysis is performed on used terms (verb, adjectives, etc. . . . ) as well on the way they are used inside a phrase to express a concept.

There can also be combination phrases. Emotions can be established in a static way or in the moment of the discussion engine personalization. Also, similarly to what is described above, it is possible to combine (in a discrete mode) an emotional intensity with different ways of communicating concepts. It is moreover possible to manage an emotional mix (several emotions expressed simultaneously).

There are some peculiarities for this type of analysis (peculiarities we discuss in § “Emotional Ambiguity Management”):
Even if what was said above is valid for any type of written text, the percentage of analysis veracity is as high as the degree to which the user is free to express himself. So it's more reliable for a free text analysis than for one bound by any kind of format (i.e.: SMS requires a text format not exceeding 160 digits).
Among interaction methods allowed to user, the written one is the less instinctive and thus is the most likely to create a “false truth.” The time needed for writing activity usually allows the rational part of ones brain to prevail over the instinctual part, thus stifling or even concealing the real emotion experienced by the writer. This is taken into account by building an A.I. model which receives, in incoming messages, a variety of emotional inputs used to compute user's emotional status.

In one embodiment, to address this problem, a plug-in is installed on the client user computer which is able of monitor the delay before a user starts writing a phrase, the time required to complete it and thus an inference of the amount of thinking over of the phrase by the user while composing. This data helps to dramatically improve weighing the veracity of text analysis.

Speaking Linguistic Analysis

The system of the invention relies on a voice recognition system (ASR) which interprets the spoken words and generates a written transcription of the speaking. The result is strongly bound by format. The ASR may or may not correctly interpret the resonant input of the speech).

Also in this case there are typical differences depending on the voice recognition system used:
ASR “word spotting” type (or rather so used). They can be useful only if are shaped to recognize word or “symbol” expressions (see § “Written linguistic analysis”).
ASR “speak freely” type or “natural speech”. In this case, output is comparable to that obtainable from a formatted text (in which the bond is set by limited allowed time tempo to pronounce phrases and by considering that ASR anyway “normalizes” what is told in standard phrases, during the transcription operation).

It is anyway important to outline that in this field technology is permanently in evolution and it will probably soon be possible to receive as a spoken input some phrases comparable to free ones of a written text.

A remarkable difference with written analysis is that in speaking a user preserves that instinctiveness peculiarity which enhances the veracity percentage of emotional analysis (see § “Emotional Ambiguity Management”).

Also in this case it is possible to obtain a better weighing of analysis veracity by insertion of an application to monitor the delay generated by user in phrase creation and in the time spent to complete it.

Gesture Analysis

Dynamics and analysis methods for gestural expression are similar to those used for facial expressions analysis (see § “Facial Expressions Analysis”). In this case elements to be

analyzed are:

hands

arms

bust

head

legs and feet

Hands and hands analysis is very important (especially for latin culture populations).

The main differences from facial expressions analysis are:
the importance of spatial motions monitoring, in particular advancing and retreating motions which are strong indicators of interest and mistrust, respectively.
it is difficult to encode a sole univocal dormant position, but it is possible to select it from among a set of “interaction starting postures,” as a starting position is greatly dependant on the surrounding environment.

In this type of interactions there are some gestures through which user is willing to make explicit an emotion, and that are so handled by the same standards used for symbols (see § “Symbol Analysis”). Typical examples are an erect thumb as an approval symbol, a movement forward/backward, a clenched fist, and a 90° bend of forearm to indicate full satisfaction for an achieved result.

Symbol Analysis

During interaction with a user, often some symbols (or signs) are used to indicate an emotive state. Due to their character of being an explicit act, the use of a symbol is to be considered a voluntary action and thus has a strong value of veracity. We may then split symbol usage into two macro categories:
endogenous symbols, or those symbols a user spontaneously uses and that are an integral part of his experience (i.e. some ways of saying or writing like “fantastic”, “great” or ways of gesticulating, etc. . . . ). To be in a better position of supporting this type of symbols into analysis it is important (if possible) to create some profiles of a user's ways of saying, doing, making (see § “User Profiles Analysis”);
suggested symbols, or those symbols that do not belong to a user's cultural skill but that might be proposed to a user to help him giving an emotional emphasis to concepts expressed. Emoticons typically used in e-mails and SMS are examples of suggested symbols whose spread have transformed them into endogenous symbols.

In one embodiment, maps of correspondence are created for suggested symbols and other symbols created ad hoc to facilitate an emotional transmission. As an example it is possible to set an arbitrary language with a gestures or words sequence, that send a not explicit command to the VA. In this way we are able to manage a standard interaction with a user where some shared symbol can modify VA behavior (and not only this). In one example a virtual butler is able to maintain a different behavior with its owner compared to other users.

Generally the VA is designed to receive “n” input types and, for each one, to evaluate the emotional part and its implications. A VA whose features are extended to environmental inputs is able to be extremely effective in managing critical situations. Environmental inputs may come from various sources:

an anti-intrusion alarm system

sensors of automatic control on an industrial plant, a bridge, a cableway, etc.

domotic (home automation) systems

other

Alterations on of the regular operating conditions of such systems, which are external to the VA, can affect the answers and/or proactive responses the VA provides to its users. The VA, as a true expert/intelligent system equipped with an emotive layer, is able to inform users about systems status in an appropriate way.

Environmental Analysis

A further element taken into consideration with respect to emotions input collection and subsequent user's emotional status identification, is comprehension of “sensations” emanated by the environment surrounding the user that may influence the user's emotional state. As an example, if a VA interacts with a user by means of formatted written text (and therefore hard to be analyzed) but is able to survey an environment around the user conveying fear or undergoing a stimulus that would create fear, than the interface is likely to detect and appropriately respond to fear even if the writing analysis doesn't show the sensation of fear. This type of analysis can be performed first by configuring system so that it is able to identify a normal state, and then by surveying fluctuations from that state.

This fluctuation can be surveyed through two methods:
directly through the media used (i.e. during a phone call it is possible to measure background noise, and this factor has a impact on communication with the system with the transmission of an altered perception of user's emotional state);
by connecting to the VA a set of sensors to signal or detect a variation from a normal state.

Example of an application which could make use of such characteristics, is the case of two different VAs territorially spread that can receive from external sources signals that identify an approaching problem (i.e. earthquake, elevator lock, hospital crises, etc). The VA is able to react in different way based on the emotional user behavioral profile

It is also important to remark that even or some additional user physical characteristics (voice loudness, language spoken, etc. . . . ) are taken into consideration in Environmental Analysis. We are able to train the VA to identify a specific user typology (i.e. an elderly man) and then add further information to better weigh the emotive analysis veracity. The VA can then modify some output parameters (i.e. to set speaking volumes and velocity and output language) and emotive factors accordingly; i.e. a capability to recognize a spoken language enables an answer in the same language.

This characterization, banal if identified through a desired language selection by pressing a knob or a computer key, may became fundamental if identified through vocal recognition of words pronounced or written phrases, as per an emergency situation in which the user cannot keep a clearness of mind sufficient to go through canalized dialogue.

Behavioral Profile Analysis

With reference to every identified user the system is able to record all behavioral and emotional peculiarity in a database, to support a more precise weighing of emotional veracity during the analysis phase and a better comprehension of dialogues and behavior.

Profiles are dynamically updated through feedback coming from the AI engine.

Behavioral profiles are split into:
Single user behavioral profile: where a single user behavior is registered;
Cluster user behavioral profile: where behavior of a cluster of users is catalogued (i.e. cultural grouping, ethnic, etc. . . . ).

Some operations may be performed on clusters in order to create behavioral clusters better representing a service environment; in example, we might create Far-East punk cluster which is the combination of punk cluster with Far-East populations' cluster. That is, the system, during the user's behavioral analysis, takes into consideration both specificities, calculating a mid-weighted value when said specificities are conflicting.

Following the same methodology, a single user may inherit cluster specificities; i.e. user John Wang, in addition to his own behavioral profile, inherits a Far-East punks profile.

### Normalization

For the purpose of managing a dialog flow and related emotional exchange in a transparent mode to the media used between the VA and users, we have implemented a protocol VAMP 1.0 (Virtual Assistant Modular Protocol 1.0). This protocol is in charge of carrying all input information received, and previously normalized, to internal architectural stratus, in order to allow a homogeneous manipulation. This allows black box 12 to manage a dialogue with a user and related emotion using the input/output media.

Caronte is the layer appointed to perform this normalization. Its configuration takes place through authoring tools suitably implemented which allow a fast and secure mapping of different format inputs into the unique normalized format.

In output Caronte similarly is in charge of converting a normalized answer into its different media dependent declinations. In § “Output Emotions Arrangement” we explain how they are transformed into output to the user.

### User's Emotion Calculation

The user's emotion calculation is performed by considering all the individual emotional inputs above and coupling them with a weighting indicative of veracity and converting them into one of the catalogued emotions. This calculation is performed in the Right Brain Engine. This new data is then input to a mathematical model which, by means of an AI engine (based on Neural Network techniques); contextualizes them dynamically with reference to:

dialog status

Environmental analysis

Behavioral profile analysis

The result is the user's emotional state, which could be a mix of emotions described below. The system can analyze, determine, calculate and represent the following primary emotional stats:

Fear

Disgust

Anger

Joy

Sadness

Surprise

and, therefore, secondary emotional states, as a combination between primaries:

Outrage

Cruelty

Betrayal

Horror

Pleasant disgust

Pain empathy

Desperation

Spook

Hope

Devastation

Hate

Amazement

Disappointment

Despite all of the actions described above, there can still be ambiguity about a user's emotive state. This happens when the analysis result is an answer with a low percentage of veracity. The system then is scheduled to make disambiguation questions which are of two types:
bound to solve ambiguity, if context so allows. So, if the system has computed a state of disappointment at 57% (combination of basic emotions of Sadness and Surprise) than VA could directly ask: “Are you disappointed by my answer?”.
Misleading the user by doing something other than what the user expects. That is, if the context so allows, “wrongfooting” the user in order to avoid the user's behavioral stiffness and to take the user by surprise in order to bring on a more instinctive reaction. Examples from human interactions are selling techniques based on sudden and wrong footing affirmation in order to surprise and catch someone's attention. So, for example, the VA could start with general purpose “chatting” to ease the tension and drive the user towards a more spontaneous interactions.

The user emotion calculus is only one of the elements that work together to determine a VA's answer. In the case of low veracity probability, it has less influence in the model for computing an answer (see § “How emotions influence calculation of Virtual Assistant's answer” and “Virtual Assistant's emotion calculation”).

### Virtual Assistant's Emotion Calculation

An AI engine (based on neural networks) is to compute VA's emotion (selected among catalogued emotions, see § “User's emotion calculation”) with regard to:

User's emotional state (dynamically calculated)

Dialogue state (dynamically calculated)

User's profile (taken from database)

Environment state (dynamically calculated)

Emotive valence of discussed subject (taken from knowledge base)

Emotive valence of answer to be provided (taken from knowledge base)

VA's emotional model (into A.I. engine)

The outcome is an expressive and emotional dynamic nature of the VA which, based on some consolidated elements (emotive valence of discussed subject, answer to be provided and VA's emotional model) may dynamically vary, real time, with regard to interaction with the interface and the context.

In order to get to a final output the system includes a behavioral filter, or a group of static rules which repress the VA's emotivity, by mapping service environment. E.g., a VA trained in financial markets analysis and in trading on-line as a bank service has to keep a stated behavioral “aplomb,” which is possible to partially neglect if addressing students, even if managing the same argument with identical information.

### Output Emotions Arrangement

Output Arrangement is performed by the Caronte module which transforms parameters received by the system though the VAMP protocol into typical operations for relevant media. Possible elements to be analyzed to define emotions can be catalogued in the same way that possible elements for arrangement by the VA may be listed:

facial expressions (visemi) and gesture

voice

written and spoken text

emotional symbols usage

environmental variations

Arrangement Through Facial Expressions (Visemi) and Gesture

Once calculated, an output emotion (see § “Virtual Assistant Emotion Calculation”) is represented by a 3D or 2D rendering needed to migrate from an actual VA expression and posture to the one representing the calculated emotion (emotions catalogued as per § “Virtual Assistant Emotion Calculation”).

This modality can be managed through three different techniques:
an application to be installed on a client, whose aim is to perform a real-time calculus for a new expression to be assumed;
real-time rendering possibility (2D or 3D) on the server side to provide continuous streaming towards clients (by means of a rendering server). To solve possible performance problems one embodiment uses a predictive rendering algorithm, able to anticipate the temporal stage “t-n” rendering that is required at stage “t,” and then sensibly enhance system performance. Test have shown that, with reference to some service typologies (typically those of informative type), the system of this invention is are able to enhance performance by 80% compared to real-time rendering with predictive rendering techniques, even keeping unaltered the interaction dynamic.
batch production of micro-clips representing visemi to be then assembled ad hoc with techniques similar to those adopted on vocal synthesis.

The joint usage of all three techniques enables the system to obtain animation results of the VA similar to those of movies, keeping unaltered the interaction dynamic.

Another embodiment provides the capability to reshape a face in real-time in order using morphing techniques to heighten the VA appearance to exalt its emotivity. In fact, with the same number of vertexes to be animated, we don't need to load a brand new visual model (a new face) to migrate from face A to a mostly similar face A1 (to extend the neck, the nose, enlarge the mouth, etc.). This isn't actually a new model but a morphing of former one. So, with a limited number of “head types”, we are able to build a large number of different VAs, simply by operating on texture and on model modification real-time in the player. From the emotional side, this means an ability to heighten appearance to exalt relevant emotion (i.e. we are able to transform, with real time morphing, a blond angel into red devil wearing horns without recalculating the model).

Arrangement Through Voice

There are two situations:
TTS (Text-To-Speech) does support emotional tags, in this case the task is simply managing a conversion of the emotion we want to arrange through VAMP in the combination of emotional tags provided by the TTS supplier.
TTS (Text-To-Speech) does not support emotional tags, in this case we have to create ad hoc combinations of phonemes or vocal expressions properly representing the emotion to be provided.
   Arrangement Through Written Text and Speaking

Similarly to what is specified about the emotion collection phase, one embodiment can arrange emotions in the output by using two techniques:
by inserting into dialog some words, expressions or phrases that, like symbols, are able to make explicit a emotional status (i.e. “I'm glad I could find a solution to your problem”)
by building some phrases with terms (verb, adjectives, . . . ) able to differentiate emotive status of the VA, like: “I cannot solve your problem” instead of “I'm sorry I cannot solve your problem” instead of “I'm absolutely sorry I cannot solve your problem” instead of “I'm prostrate I couldn't solve your problem”)

This fixed combination phrases-emotions is statically created in the moment of the discussion engine personalization and, similar to other features discussed, it is possible to combine (in a discrete mode) an emotional intensity with different ways of communicating concepts and it is possible to manage an emotional mix (several emotions expressed simultaneously).

Arrangement Through Emotional Symbols

Emotions can be transmitted to the user through the VA using the description in § “Symbols Analysis” but in a reverse way. The system performs a mapping between symbols and emotions allowing the usage in each environment of a well known symbol or a symbol created ad hoc, but tied to cultural context. The use of symbols in emotive transmission is valuable because it is a communication method which directly stimulates primary emotive stats (i.e. like red color usage in all signs advising a danger).

Arrangement Through Environmental Variations

The system provides in one embodiment the use of environmental variations to transmit emotions. Thus, it is easy to understand the value of a virtual butler who, once it captures the emotive state of the user, could manage a domotic system to reply to an explicit emotive demand.

This concept is applicable, with inferior valences, to environments technologically less advanced. In one embodiment, the VA manages sounds and colors having an impact on transmission of emotive status. In one example, if a task is to transmit information carrying a reassuring emotive content, the VA could operate and appear on a green/blue background color while, to recall attention, the background should turn to orange. Similar techniques can be used with sounds, the management of a character in supporting written text, or voice timbre, volume and intensity.

All these characteristics are managed through tools which allow creating any relationship, customizable, between environmental elements and emotions, and there is no limit to the number of simultaneous relationships to be created and managed.

### How Emotions Influence Calculation of Virtual Assistant's Answer

In order to explain how emotions influence Virtual Assistant's answers it's useful to shortly introduce a framework based on AI which is used for dialog flow management. This man/machine dialog is aimed at two targets (not mutually exclusive):

identify a user's need and/or

solve a problem

Flow handler (Janus) module 42 is the element of architecture appointed to sort and send actions to stated application modules on the basis of dialog status.

User's Need Identification

Architectural modules appointed to a user's need identification are:

Discussion Engine 44

Events Engine 46

Left Brain module 54

Discussion Engine 44 is an engine whose aim is to interpret natural speaking and which is based on adopted lexicon and an ontological engine. Its functionality is, inside a received free text, to detect elements needed to formulate a request to be sent to the AI engines. It makes use of grammatical and lexical files specific for a Virtual Assistant which have to be consistent with decision rules set by AI engines.

The format of those grammatical files is based upon AIML (Artificial Intelligence Markup Language) but is in a version modified and enhanced in one embodiment to give a format we call VAGML (Virtual Assistant Grammar Markup Language).

Events Engine 46 needs to resolve the Virtual Assistant's “real-time” reactions to unexpected events. The flow handler (Janus) first routes requests to Events Engine 46, before transmitting them to the AI Engines. Event Engine 46 analyzes requests and determines if there are events requiring immediate reactions. If so, Event Engine 46 can therefore build EXML files which are sent back to Caronte before the AI Engines formulate an answer.

There are two main typologies of events managed by Event Engine:
1. Events signaled in incoming messages from Caronte applications: i.e. in case of voice recognition, the signaled event could be “customer started talking”. This information, upon reaching the Event Engine, could activate an immediate generation of a EXML file with information relevant to a rendering for an avatar acting a listening position, with the file to be immediately transmitted to the Caronte application for video implementation to be afterwards transmitted to client application.
2. Events detected by the Event Engine itself: i.e. a very light lexical parser could immediately identify the possible presence of insulting wording and, through the same process described above, Event Engine can create a file of reaction for Virtual Assistant avatar of surprised position, before a textual answer is built and dispatched.

Right Brain 52 functionalities, an engine based on neural networks, are explained above in § “Virtual Assistant's emotion calculation”.

By means of this interrupt, analysis and emotion calculation mechanism, it is then possible to stop dialog flow, due to the fact that the Events Engine has captured an emotive reaction asynchronous with reference to dialog. The influence on dialog flow might be:
temporary—freezing dialog for the timeframe needed to answer precisely to asynchronous event;
definitive—the Events Engine transfers asynchronous emotional input to Right Brain 52 which adjusts the dialog to the new emotional state or by modifying the dialog flow (a new input is taken from neural network and so interaction is then modified accordingly) or by modifying weights of emotional states thus further modifying the intensity of transmitted emotions, even if keeping the same dialog flow (see § “Output Emotions Arrangement”).

If on the contrary the Events Engine does not intervene, then dialog is solely driven by Discussion Engine 44 which, before deciding which stimulus is next to be presented to the user, interrogates Right Brain 52 to adjust, as outlined above, the influence on dialog flow of the definitive type.

A dialog flow is modified only in case of intervention of emotional states asynchronous with reference to it (so interaction determined to need identification has to be modified), while otherwise emotion has influence only on interaction intensity modifications and on its relevant emotional manifestations, but does not modify the identified interaction path.

Problem Solving

Architectural modules appointed to solve a problem are:

Events Engine 46

Left Brain 54

Right Brain 52

In one embodiment, Left Brain 54 is an engine based on Bayesian models and dedicated to issue solving. What is unique in comparison with other products available on the market is an authoring system which allows introducing emotional elements that have an influence on mathematical model building.

The expert system according to one embodiment of the invention computes an action to implement considering:
historical evidence: a group of questions and remarks able to provide pertinent information about the problem to solve.
list of the set of events or symptoms signaling an approaching problem
analysis of experts providing know-how on problem identification and relationships among pertinent information.
set of solutions and their components dedicated to solve a problem and their relation with solvable problems.
error confidence based on historical evidence.
sensibility, or a mechanism which allows formulating the best question or test and to perform a diagnosis based on information received.
decisional rules, or an inferential motor or engine basis.
utility, or the capability of providing some information in incoming messages with a probabilistic weight which has an influence on decisions (i.e. interface standing and importance).
   Right Brain Authoring Desktop

Finally, as perception of information in the input is destined to modify both dialog flow and answers, the emotions arrangement in the output is mainly dedicated to reinforce concepts to drive to a superior comprehension and to generate stimulus to the user to enhance data quality in the input, thus providing answers and solutions tied to needs.

An embodiment of the present invention includes an authoring system which allows insertion into the system of emotional elements to influence decisions on actions to be taken. In particular, there is intervention on:
signaling when the appearance of a stated user emotion might be a signal of a rising problem.
identifying when a stated emotion of a user modifies error confidence.
signaling when the appearance of a stated user emotion has an influence on system sensibility.
identifying when a user's emotion modifies the probabilistic weight of utilities.

The goal of the authoring desktop is to capture and document intellectual assets and then share this expertise throughout the organization. The authoring environment enables the capture of expert insight and judgment gained from experience and then represents that knowledge as a model.

The Authoring Desktop is a management tool designed to create, test, and manage the problem descriptions defined by the domain experts. These problem descriptions are called “models”. The Authoring Desktop has multiple user interfaces to meet the needs of various types of users.

Domain Experts user interface. Domain experts will typically use the system for a short period of time to define models within their realm of expertise. To optimize their productivity, the Authoring Desktop uses pre-configured templates called Domain Templates to create an easy to use, business-specific, user interface that allows domain experts to define models using their own language in a “wizard”-like environment.

Modeling Experts user interface. Modeling experts are long time users of the system. Their role includes training the domain experts and providing assistance to them in modeling complex problems. As such, these experts need a more in depth view of the models and how they work. The Authoring Desktop allows expert modelers to look “under the hood” to better assist domain modelers with specific issues.

Application Integrators user interface. Data can be provided to the Right Brain environment manually through a question and answer scenario or automatically through a programmatic interface. Typically, modelers do not have the necessary skills to define the interfaces and an IT professional is needed. The Authoring Desktop provides a mechanism for program integrators to create adaptors necessary to interface with legacy systems and/or real-time sensors.

### Pure Emotional Dialogue

As described above, the virtual assistant can respond to the emotion of a user (e.g., insulting words) or to words of the user (starting to answer) with an emotional response (a surprised look, an attentive look, etc.). Also, the virtual assistant can display emotion before providing an answer (e.g., a smile before giving a positive answer that the user should like). In addition, even without verbal or text input, a user's emotion may be detected and reacted to by the virtual assistant. A smile by the user could generate a smile by the virtual assistant, for example. Also, an emotional input could generate a verbal response, such as a frown by the user generating “is there a problem I can help you with?”

### Emotion as Personality or Mood

In one embodiment, the emotion generated can be a combination of personality, mood and current emotion. For example, the virtual assistant may have a personality profile of upbeat vs. serious. This could be dictated by the client application (bank vs. Club Med), by explicit user selection, by analysis of the user profile, etc. This personality can then be modified by mood, such as a somewhat gloomy mood if the transaction relates to a delayed order the user is inquiring about. This could then be further modified by the good news that the product will ship today, but the amount of happiness takes into account that the user has been waiting a long time.

It will be understood that modifications and variations may be effected without departing from the scope of the novel concepts of the present invention. For example, the expert system of the invention could be installed on a client server. Accordingly, the foregoing description is intended to be illustrative, but not limiting, of the scope of the invention which is set forth in the following claims.

What is claimed is:

1. A virtual assistant comprising:
a user input for providing information about a user emotion;
an input transform module for transforming said information into normalized emotion data; and
a core module for producing a virtual assistant emotion for the virtual assistant based on detected user emotion.

2. The virtual assistant of claim 1 further comprising an adjustment module configured to apply an adjustment to the degree of said virtual assistant emotion based on a context.

3. The virtual assistant of claim 2 wherein said context comprises one of a user profile and a type of service provided by said virtual assistant.

4. The virtual assistant of claim 1 further comprising an output transform module configured to transform a normalized emotion output for said virtual assistant into one of a voice rendering, a video, and a text message.

5. The virtual assistant of claim 1 further comprising:
a right brain module configured to determine a probability of veracity of said user emotion;
said right brain module being further configured to compare said probability to a threshold; and
said right brain module being further configured to formulate a stimulus to provide more data to determine said user emotion if said probability is below said threshold.

6. A virtual assistant comprising:
a user input for providing information about a user emotion;
a connecting layer configured to provide an output emotion prior to calculating a response to a user;
an artificial intelligence engine configured to calculate a response to a user input.

7. A virtual assistant comprising:
a user input device for providing input information from a user;
an emotion detection module configured to detect a user's emotion from said input information;
a core module for producing a virtual assistant emotion for the virtual assistant based on said user's emotion.

8. The virtual assistant of claim 7 wherein said input information is an image and said user's emotion is detected from one of a facial expression of said user and a gesture of said user.

9. A virtual assistant comprising:
a first media input from a user;
a second media input from said user;
an emotion detection module configured to detect said user's emotion from a combination of said media inputs;
a core module for producing a virtual assistant emotion for the virtual assistant based on said user's emotion.

10. The virtual assistant of claim 9 wherein
said first media input is one of a voice and text input; and
said second media input is a camera input.

11. The virtual assistant of claim 9 wherein said emotion module is further configured to consult, in determining said user's emotion, one of a user profile and group characteristics of a group said user is associated with.

12. An user help system comprising:
a user input for providing a user dialogue and user emotion information; and
an expert system for providing a response to said user dialogue, wherein said response varies based on said user emotion information.

13. The system of claim 12 wherein said response varies in one of a price and an alternative option.

14. A method for controlling a virtual assistant comprising:
receiving a user input;
analyzing said user input to detect at least one user emotion;
producing a virtual assistant emotion for the virtual assistant based on said detected user emotion;
said virtual assistant emotion also being produced based on one of a user profile and a type of service provided by said virtual assistant.

15. The method of claim 14 further comprising applying an adjustment to the degree of said virtual assistant emotion based on a context.

16. The method of claim 14 further comprising:
transforming said user emotion into normalized emotion data; and
transforming said virtual assistant emotion into a media specific virtual assistant emotion.

17. The method of claim 14 further comprising:
offering said user an accommodation in response to detection of a predetermined emotion above a predetermined level.

18. The method of claim 17 wherein said accommodation is a discount.

19. The method of claim 14 further comprising:
detecting an ambiguous user emotion; and
forming a virtual assistant question, unrelated to a current dialogue with said user, to elicit more information on an emotion of said user.
